(19) United States
(12) Patent Application Publication
(10) Pub. No.: US 2006/0144720 A1
(43) Pub. Date: Jul. 6, 2006

(54) Chemical sensors

(75) Inventors: James Durrant, London (GB); Emilio Palomares, London (GB); Ramon Vilar, London (GB)

Correspondence Address: WILMER CUTLER PICKERING HALE AND DORR LLP, THE WILLARD OFFICE BUILDING, 1455 PENNSYLVANIA AVE, NW, WASHINGTON, DC, 20004, US

(73) Assignee: Imperial College Innovations Limited, London (GB)

(21) Appl. No.: 11/169,881

(22) Filed: Jun. 30, 2005

Related U.S. Application Data
(60) Provisional application No. 60/583,895, filed on Jun. 30, 2004.

(51) Int. Cl. G01F 1/64

(52) U.S. Cl. 205/789.5

(57) ABSTRACT

The invention relates to methods for detecting metals or salts thereof in aqueous solutions, detectors for carrying out the methods, and processes for preparing the detectors. Exemplary metals include platinum, palladium, silver, mercury and gold.

### RELATED APPLICATION

This application claims priority under 35 USC § 119 to U.S. Application No. 60/583,895 filed Jun. 30, 2004.

### FIELD OF THE INVENTION

The invention relates to methods for detecting metals in aqueous solutions, devices and kits for carrying out the methods, and processes for preparing the devices and kits.

### BACKGROUND OF THE INVENTION

Sensing harmful species is critical to environmental monitoring, in the control of chemical processes and in medical applications. The selective detection of metals such as mercury is of particular importance. Mercury is both biologically highly toxic (causing damage to the central nervous system and creating neuropsychiatric disorders in humans) and a common environmental pollutant. Elementary mercury and Hg²⁺ salts are released into the environment by various processes. In addition, the most dangerous form of mercury for human health, methyl mercury is produced by the action of microorganisms on the released mercury and Hg²⁺ salts.

Existing chemical sensors for the detection of Hg²⁺ include devices based on thin films of gold, environmentally-sensitive organic molecules, polymeric materials and bio-composites. Devices based on thin-film gold layers operate at high temperatures (150° C.-300° C.) and require complicated electronic circuits for substantial sensitivity. Polymer composites exhibit limited sensitivity, while sensors based on simple organic luminophores usually only function in organic solvents, and often need long equilibrium times for quantitative detection. Similarly, limitations are encountered with biosensing of Hg²⁺ which requires the use of buffering solutions and long equilibration times before the reading can be carried out.

There is therefore a need in the art for an enhanced method of detecting metals such as mercury with improved ease and sensitivity. In particular, there is a requirement for a detector which can be used in the field to detect such metals for example in ground water, lakes, rivers etc. The invention is directed to this, as well as other, important ends.

### SUMMARY OF THE INVENTION

The invention provides methods for detecting one or more metals in an aqueous solution by contacting at least one metal organic dye with an aqueous solution comprising one or more metals selected from the group consisting of Pt²⁺ Pd²⁺, Ag⁺, Hg²⁺ and Au³⁺, wherein the presence of one or more of the metals is determined by a change in an optical and/or electrochemical property of the dye.

The invention provides methods for detecting one or more metals in an aqueous solution by contacting at least one metal organic dye with an aqueous solution comprising one or more metals selected from the group consisting of Pt²⁺ Pd²⁺, Ag⁺, Hg²⁺ and Au³⁺, wherein the presence of one or more of the metals is determined by measuring one or more optical and/or electrochemical properties of the dye.

The invention provides devices and kits for detecting the presence of one or more metals selected from the group consisting of Pt²⁺ Pd²⁺, Ag⁺, Hg²⁺ and Au³⁺ in an aqueous solution comprising a metal organic dye.

The invention provides processes for producing metal organic dye-supporting substrates by contacting at least one substrate with at least one metal organic dye.

These and other aspects of the invention are described herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The invention may be put into practice in various ways and a number of specific embodiments will be described by way of example to illustrate the invention with reference to the accompanying drawings, in which:

FIG. 1 shows the change in color of the TiO₂/N719 film in the presence of Hg²⁺. The TiO₂/N719 film was dipped for 10 minutes in a 20 μm aqueous solution of the indicated metals.

FIG. 2 shows corresponding spectral shift for TiO₂/N719 film in the presence of Hg²⁺, with the kinetics of the color change in the presence of Hg²⁺ illustrated in the insert to FIG. 2. Normalized absorption spectra of a TiO₂/N719 film were measured before (A) and after (B) the film was immersed for 10 minutes in a 4 ml quartz cuvette containing a 20 μm solution of Hg²⁺. The insert shows the kinetics of the change in absorption measured at λ=480 nm run following immersion of the TiO₂/N719 film in aqueous solutions with (a) 0 M, (b) 10⁻⁵ M and (c) 10⁻⁴ M Hg².

FIG. 3 shows the sensitivity of the TiO₂/N719 film for the detection of Hg²⁺. The Figure illustrates a titration of the change in the absorption of a N719/TiO₂ film measured at 550 nm versus the concentration of added Hg²⁺ ions. Measurements were carried out one minute after each addition of Hg²⁺ ions.

FIG. 4 is a graphical representation of the TiO₂/N719 film and its color change in the presence of Hg²⁺.

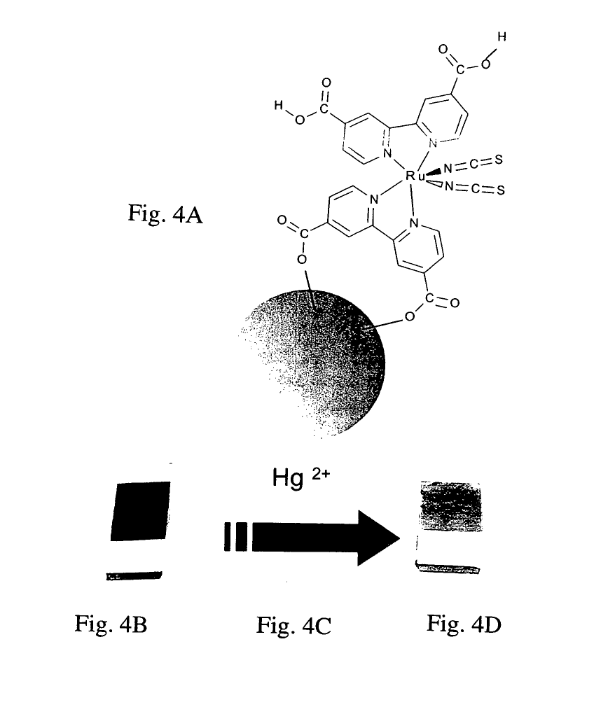

FIG. 5 illustrates the changes on the UV-vis spectra of N719 in ethanol solution measured at 530 nm versus the concentration of added Hg²⁺ (squares), Pb²⁺ (triangles) and Cd²⁺ (circles). Measurements were carried out immediately after each addition. Metal ions were added as aliquots from 1 mm aqueous stock solutions. It is apparent that the sensing function of N719 is selective for Hg²⁺.

FIG. 6 illustrates titration of the change in the absorption of N719 in HEPES buffered distilled water (pH 7.0) (KN719) measured at 500 nm versus the concentration of added Hg²⁺ ions. Measurements were carried out immediately after each addition. Mercury ions were added as aliquots from 0.1 mM aqueous stock solutions.

### DETAILED DESCRIPTION OF THE INVENTION

The first aspect of the invention provides a method of detecting one or more metals selected from Pt²⁺, Pd²⁺, Ag⁺, Hg²⁺ or Au³⁺ in an aqueous solution comprising contacting a metal organic dye with an aqueous solution comprising one or more of the metals, wherein the presence of the metal(s) is determined by a change in the optical and/or electrochemical properties of the dye. The method of the first aspect provides an improved method of detecting sub-micromolar concentrations of metals and/or organic derivatives of such metals, in particular of detecting toxic mercuric salts.

The invention provides a method of detecting a metal selected from Pt²⁺, Pd²⁺, Ag⁺, Hg²⁺ or Au³⁺ in an aqueous solution. The aqueous solution may additionally comprise a non-aqueous solution, where the non-aqueous solution is miscible or non-miscible with an aqueous solution, preferably miscible. Preferably, the solution comprises 85% or above of an aqueous solution, more preferably 95% or above, more preferably 99% or above, most preferably 100%.

For the purposes of this invention, the metal organic dye comprises a metal organic chromophore. The chromophore comprises a ligand which is sensitive to the presence of metal ions, for example, where the interaction of the ligand with a metal causes a change in the optical properties of the dye, e.g., in the optical properties of the chromophore; and/or in the electrochemical properties of the dye, e.g., in the electrochemical properties of the chromophore. Preferably the chromophore comprises a sulfur containing ligand, such as —N═C═S, —S—H, or a thiourea derivative such as —NH—C(S)—NHR wherein R is an aromatic or alkyl group preferably selected from C₁₋₁₀ alkyl or C₆₋₁₂ aryl, more preferably selected from an alkyl group having 1, 2, 3, 4, 5 or 6 carbon atoms or a phenyl or naphthyl group. More preferably the sulfur containing ligand is —N═C═S.

The metal organic dye preferably comprises a composition of Formula (I):
MLₓN_{y} (I)
wherein M is a transition or lanthanide metal; L is an organic ligand; N is a sulfur containing ligand; and X and Y are independently an integer selected from 1, 2, 3, 4, 5 or 6.

Preferably M is selected from Ru, Re, Os, Zn, Ir, Pt, Pd, Ti, V, Mn or Cr. N is preferably selected from —N═C═S, —SH or —NH—C(S)—NHR. L is preferably a chromophore, more preferably pyridine or bi-pyridine.

The ligand may contain one or more groups for attachment of the dye to the substrate. Such attachment groups may include —CO₂H, —PO₃H, —OH or —SO₃H.

In a preferred feature of the first aspect of the invention, the metal organic chromophore is bis(2,2′-bipyridyl-4,4′-dicarboxylato)ruthenium(II) bis-tetrabuytlammonium bis-thiocyanate (N719).

In a feature of the first aspect, the metal organic dye can be solubilized into a solution phase prior to carrying out the method of detection described herein. The metal organic dye can be solubilized into an aqueous liquid phase or a water miscible organic solvent liquid phase. The metal organic dye may additionally comprise one or more solubilizing ligands wherein such ligands may be selected from one or more of a hydrophilic sugar, protein and/or polymer. More preferably the solubilizing ligand is one or more of albumin, dextran, sepharose, polyribose, polyxylose, polyvinyl alcohol, ethylene glycol and/or propylene glycol.

In a preferred feature of the first aspect the metal organic dye is a compound of Formula (II): 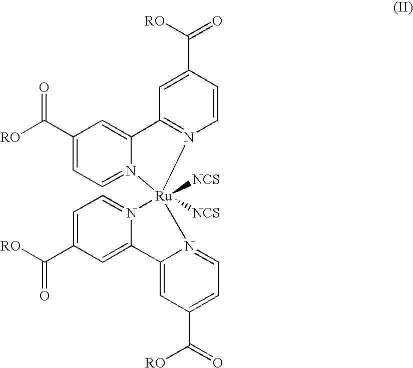
wherein each R is independently hydrogen or a solubilizing ligand as discussed above.

In an alternative feature of the first aspect the metal organic dye can be supported on a substrate. Preferably the substrate is a metal oxide film, an optionally transparent polymer film and/or an alumina silicate (Zeolite). More preferably the substrate is a metal oxide film. The metal oxide film, optionally transparent polymer film and/or an alumina silicate (Zeolite) preferably have a high surface area.

The metal oxide film for the invention comprises a mesoporous nanocrystalline metal oxide. In particular, the metal oxide selected from ZnO₂, ZrO₂, TiO₂, SiO₂, SnO₂ CeO₂, Nb₂O₅, WO₃, SrTiO₃ or mixtures of two or more thereof, preferably TiO₂. The film preferably comprises nanometer sized crystalline particles having a typical diameter of from about 5 to about 50 nm, wherein the densely packed particles form a mesoporous structure providing a high surface area.

Mesoporous nanocrystalline metal oxide films, such as TiO₂ films, have a high surface area and an excellent optical transparency in the visible region of the spectrum (e.g., λ>400 nm). These metal oxide films are therefore particularly useful for use in optical detection.

In a particularly preferred feature of the first aspect, the metal organic dye-supporting high surface area metal oxide film is TiO₂ bis(2,2′-bipyridyl-4,4′-dicarboxylato)ruthenium(II) bis-tetrabuytlammonium bis-thiocyanate.

The presence of a metal in an aqueous solution is detected by a change in the optical and/or electrochemical properties of the supported dye. The change in the optical properties can be determined by eye (i.e., visually) or can be measured by spectroscopy, for example, by IR, UV-vis absorption, luminescence and/or Raman spectroscopy.

In a preferred feature of the first aspect, the change in the optical properties is determined by a change in the color of the supported dye. This color change can be determined visually, providing a quick and easy method for determining the presence of a metal in solution.

The change in the electrochemical properties of the dye, for example the changes in the reduction or oxidation potential of the dye induced by the presence of a metal, can be detected by means of electrochemical methods, such as cyclic voltammetry and methods based on cyclic voltammetry.

The change in the optical and electrochemical properties of the dye can be detected by spectroelectrochemical methods, such as by means of UV-vis absorption and cyclic voltammetry.

In a preferred feature of the first aspect, there is provided a method for detecting mercury in an aqueous solution, the method comprising contacting a metal organic dye-supporting substrate with an aqueous solution comprising mercury, wherein the presence of mercury in the aqueous solution is determined by a change in the optical and/or electrochemical properties of the dye. Preferably the presence of mercury in the aqueous solution is determined by a change in the optical properties of the supported dye.

The method of the first aspect allows the detection of mercury ions such as Hg²⁺. In particular, the method can be used to detect organic derivatives of mercury such as methyl mercury.

Mercury can be detected in solution by a change in the absorption of the dye, preferably of the supported dye. In particular, when the metal organic dye is supported on the high surface area metal oxide film TiO₂ bis(2,2′-bipyridyl-4,4′-dicarboxylato)ruthenium(II) bis-tetrabuytlammonium bis-thiocyanate, the presence of mercury is detected by the change in the absorption of the supported dye from about 535 nm to about 481 nm, when the metal organic dye-supporting high surface area metal oxide film is contacted with mercury.

Mercury may alternatively or in addition be detected in solution by detecting a change in the reduction and oxidation potential of the dye, preferably of the supported dye. The change in the reduction and oxidation potential of the dye can be detected by electrochemical methods, such as cyclic voltammetry.

The method of the first aspect allows the detection of mercury in an aqueous solution with a rapid response, high selectivity and a sub-micromolar sensitivity for Hg²⁺.

It is proposed that the metals such as Hg²⁺ interact with the sulfur containing ligands of the organic metal dye.

The first aspect of the invention provides a practical method for the colorimetric and/or spectrophotometric sensing of Hg²⁺ in aqueous solutions at room temperature. Furthermore, the method of the first aspect provides a particular selectivity for the metals Hg²⁺, Pt²⁺, Pd²⁺, Ag⁺ or Au³⁺. Investigations have determined that the metals Pt²⁺, Pd²⁺, Ag⁺, Au³⁺ or Hg²⁺ can be specifically detected in the presence of other metals such as Ca²⁺, Mg²⁺, Mn²⁺, Fe²⁺, Cd²⁺, Co²⁺, Cu²⁺, Pb²⁺, Ni²⁺, and Zn²⁺.

As previously discussed, there is a particular need in the art for the environmental monitoring of harmful species such as metals. In particular, the invention provides a method for detecting the presence of metals, in particular mercury, in aqueous solutions such as river water, sea water, ground water, drinking water, and the like. The method of the first aspect can further be provided to detect the presence of a metal in a biological or medical sample, including blood products and urine. The biological or medical sample can be fluid and/or tissue. In a particular preferred feature of the first aspect, the invention provides a method for detecting the presence of metals, in particular mercury, wherein the aqueous solution is drinking water.

The method of the first aspect can be used to detect the presence of a metal in samples of aqueous solutions, i.e., samples of water can be removed from a lake, river or drinking water and the presence of one or more metals can be detected as set out in the first aspect. Alternatively the metal organic dye-supporting substrate could be placed into an aqueous solution, e.g., the film could be placed into a river, lake, drinking water, etc., and multiple a readings could be taken, for example readings taken at one or more time intervals over a period of 1 day, 1 week, 1 month, or the like.

The method of the first aspect can be used for array sensing, thereby allowing the sensing of different analytes and/or analyte concentration ranges.

It will be appreciated that in addition to providing a method for detecting a metal in an aqueous solution, the change in the optical and/or electrochemical properties of the dye could also be used to provide a measure of the concentration of the detected metal. The invention therefore provides a method of determining the concentration of one or more metals selected from Pt²⁺, Pd²⁺, Ag⁺, Hg²⁺ or Au³⁺ in an aqueous solution comprising contacting a metal organic dye with an aqueous solution, comprising one or more metals, wherein the concentration of the metal is determined by measuring the optical and/or electrochemical properties of the dye. Preferably, the metal organic dye is supported on a substrate.

The second aspect of the invention provides a process for the production of a metal organic dye-supporting substrate comprising contacting a substrate with a metal organic dye. For the purposes of the second aspect the substrate is preferably a metal oxide film.

Preferably, the metal organic dye is absorbed onto the substrate, for example the metal oxide film. The metal oxide may be deposited via screen printing, spin coating, doctor blading or inkjet printing. The substrate, for example the metal oxide film, may subsequently undergo one or more additional processing steps such as heat sintering, low temperate compression and/or compression.

The third aspect of the invention provides a detector for detecting the presence of a metal selected from Pt²⁺, Pd²⁺, Ag⁺, Au³⁺, or Hg²⁺ in aqueous solution comprising a metal organic dye. The detector can be a device or a kit.

The metal organic dye preferably comprises a composition of Formula (I):
MLₓN_{y} (I)
as defined in the first aspect of the invention. Alternatively, the metal organic dye can be a compound of Formula (II) as defined in the first aspect of the invention.

The metal organic dye is preferably supported on a substrate. For the purposes of the third aspect, the substrate is preferably a high surface area metal oxide film.

The metal organic dye is attached to the substrate, for example to a metal oxide film, covalently, ionically, non-covalently, by absorption or by a combination thereof. The metal organic dye may comprise one or more groups for attachment of the metal organic dye to the metal oxide film. Such attachment groups may include —CO₂H, —PO₃H, —OH and/or —SO₃H.

The detector may additionally comprise an optical sensor for detecting the presence of the one or more metals by determining the change in the optical properties of the dye. The optical sensor may be a spectrometer which can determine the change in the optical properties of the dye by IR, UV-vis absorption, UV-vis emission, luminescence and/or Raman spectroscopy.

The detector may provide a qualitative indication of the presence of a metal by, for example, a color change which may be determined visually or by spectroscopy or by an indication on a display screen such as an LCD. Alternatively the detector may give a quantitative indication of the presence and/or concentration of a metal. Such a quantitative indication may be obtained by measuring and displaying the concentration of a metal in a sample for example on a display screen such as an LCD. The concentration may be displayed in units of molarity, ppm, and the like. Alternatively the resulting color obtained on incubation of a metal with the dye can be quantified to give an indication of concentration, i.e., by preparing a comparison of absorbance with concentration, for example a standard curve or calibration chart, and comparing the obtained color thereto. The detector may additionally comprise a display screen, such as an LCD.

Alternatively or in addition the detector may comprise an electrochemical sensor for detecting the presence of one or more metals by determining a change in the electrochemical properties of the dye. The electrochemical sensor may be based on a semiconductor or conductive surface in contact with a molecular sensor.

The metal organic dye-supporting substrate may be supported on a support surface, for example, a polymeric and/or silicate glass matrix. The substrate may cover all or a part of the support surface. In a preferred feature of the third aspect, the dye may contain one or more additional ligating groups to attach the metal organic dye-supporting substrate to the support surface.

In a preferred embodiment of the third aspect, the metal organic dye-supporting substrate forms an array on the support surface. The metal organic dye-supporting substrate can therefore provide a conveniently shaped sensing area on the support surface. In a particularly preferred embodiment of the third aspect, the array allows for the provision of different dyes or the alteration of the loading of the dye on different portions of the array, thereby allowing the sensing of different analytes and/or analyte concentration ranges. The array can be provided as discrete areas or dots on a sensor surface, for example by screen printing.

The fourth aspect relates to a process for the production of a detector as defined in the third aspect comprising the application of the metal organic dye supporting substrate to a support surface, the application being carried out with the application of heat and/or pressure.

Alternatively, the detector may be produced by the application of the substrate, for example, a high surface area metal oxide film to a support surface followed by the addition of the metal organic dye. For the purposes of all features of the fourth aspect, the metal oxide film and/or the metal organic dye may be applied by screen printing.

The fifth aspect of the invention relates to the use of a detector as defined in the third aspect of the invention for detecting one or more metals selected from Pt²⁺, Pd²⁺, Ag⁺, Hg²⁺ and/or Au³⁺, comprising contacting the detector with an aqueous solution comprising one or more metals and determining the presence of one or more of the metals by detecting the change in the optical and/or electrochemical properties of the dye.

In addition, the detector as defined in the third aspect of the invention can be used to determine the concentration of one or more metals selected from Pt²⁺, Pd²⁺, Ag⁺, Hg²⁺ and/or Au³⁺, the method comprising contacting the detector with an aqueous solution comprising one or more metals and determining the concentration of one or more of the metals by measuring the optical and/or electrochemical properties of the dye.

All preferred features of each of the aspects of the invention apply to all other aspects mutatis mutandis.

### EXAMPLES

The invention will now be illustrated by reference to one or more of the following non-limiting examples.

### Example 1

### Preparation of TiO₂/bis(2,2′-bipyridyl-4,4′-dicarboxylato)ruthenium (II) bis-tetrabutylammonium bis-thiocyanate

The bis(2,2′-bipyridyl-4,4′-diarboxylatoruthenium (II) bis-tetrabutylammonium bis-thiocyanate (N719) complex was adsorbed onto a 4 μm thick TiO₂ film by soaking the film in 1 mM solution of the dye in a 1:1 mixture of acetonitrile/tert-butanol at room temperature overnight.

### Example 2

### Cation Detection

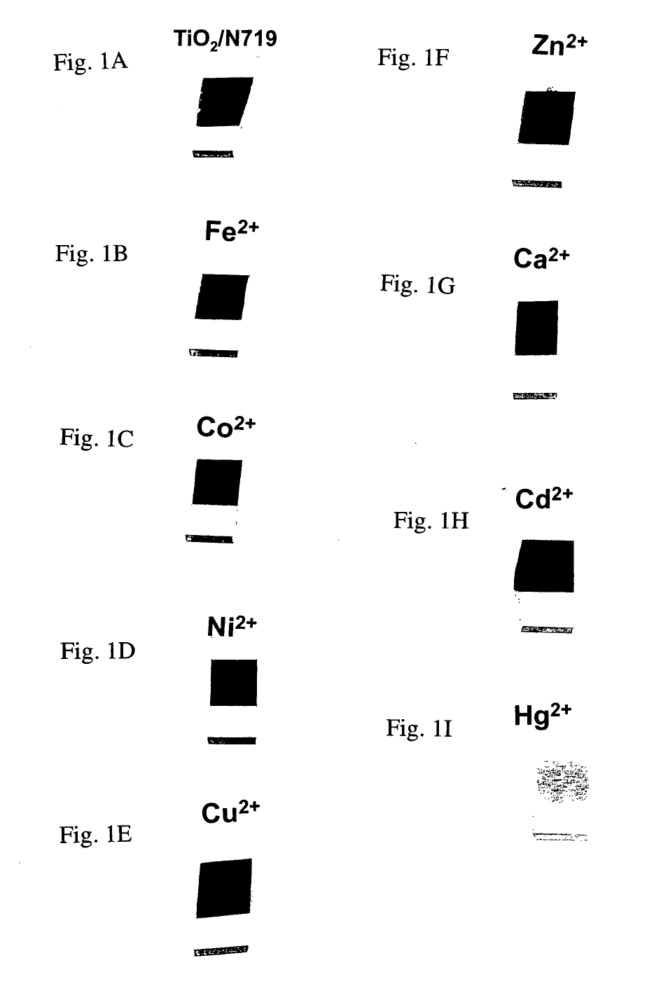

The cation detecting experiments with the TiO₂/N719 films were carried out in distilled water (˜pH 5) by exposing the films to micromolar solutions of the metal cations under study (i.e., Ca²⁺, Mg²⁺, Mn²⁺, Fe²⁺ Cd²⁺, Co²⁺, Cu²⁺, Hg²⁺, Ni²⁺, Pb²⁺ and Zn²⁺). As illustrated in FIG. 1, the TiO₂/N719 film demonstrated a change in its color in the presence of Hg²⁺.

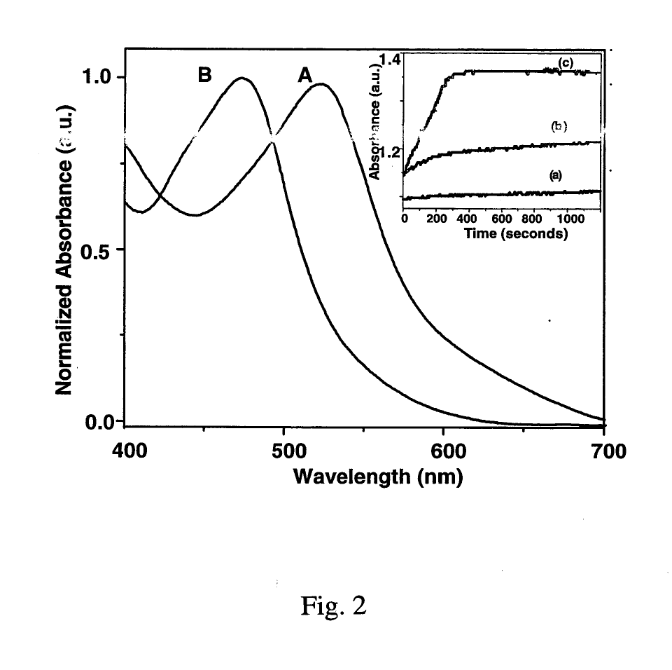

FIG. 2 shows the corresponding spectral shift, with Hg²⁺ immersion resulting in a hypsochromic shift of the N719 visible absorption band from 535 nm to 481 nm. No optical changes of the films were observed with Ca²⁺, Mg²⁺, Mn²⁺, Fe²⁺ Cd²⁺, Co²⁺, Cu²⁺, Ni²⁺, Pb²⁺ and Zn²⁺ even when the films were exposed to millimolar concentrations. The kinetics of the color change in the presence of Hg²⁺ were observed to be dependent upon the concentration of Hg²⁺ (see insert FIG. 2), ranging from seconds at millimolar concentrations to minutes at low concentrations. This color change was found to be irreversible, persisting for several weeks and being insensitive to subsequent drying of the film and rinsing in Hg²⁺ free control solutions.

### Example 3

### Effect of Other Cations and Anions on Mercury Detection

The color change in the presence of Hg²⁺ was found to be insensitive to interference by other metal cations. A TiO₂/N719 film was exposed to a solution containing sub-micromolar amounts of Hg²⁺ and micromolar quantities of all the other metal cations under study. The optical changes of the film were identical to those observed for solutions containing only mercury, demonstrating the lack of interference by other cations. Similarly, the effect of anionic species was studied by adding to the Hg²⁺ solution micromolar amounts of F⁻, Cl⁻ Br⁻, I⁻, AcO⁻, NO₃⁻ and HSO₄⁻ (as their tetrabutylammonium salts). No interference in the presence of these anionic species was observed.

### Example 4

### Investigation of the Sensitivity of TiO₂/N719 Film

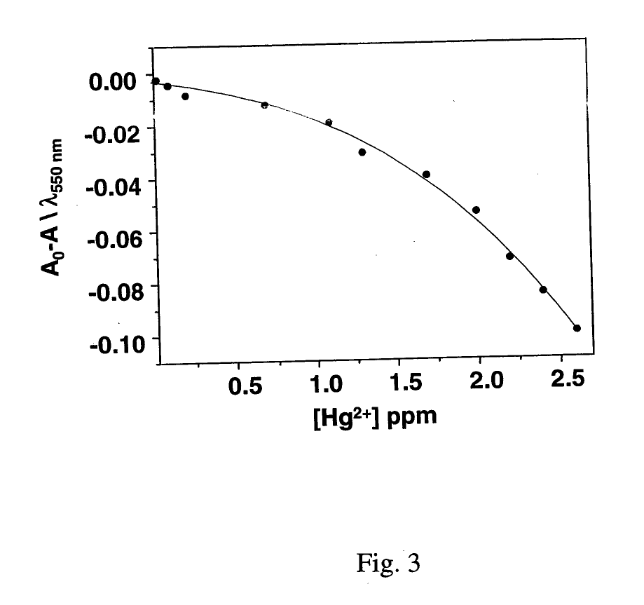

The sensitivity of the TiO₂/N719 film for the detection of Hg²⁺ cations was investigated by “naked eye” (e.g., visually) and spectrophotometric studies as a function Hg²⁺ concentration. “Naked eye” detection was found to be possible down to about 20 μM of Hg²⁺. Spectrophotometric detection allowed the sensing down to about 0.3 μM of Hg²⁺ (e.g., about 0.5 ppm of Hg²⁺), as illustrated in FIG. 3.

The origin of the sub-micromolar sensitivity of this sensing system to Hg²⁺ requires careful consideration. The TiO₂/N719 films employed in this study have an area of 1 cm² and bind approximately 300 nanomols of ruthenium dye (determined from the film optical density, and employing a N719 extinction coefficient of 12,000 Mol⁻¹ cm at 535 nm). We observe that complete color change of the film from red-purple (λ=535 nm) to yellow (λ=481 nm) occurs at levels of mercury as low as 60 nanomoles (20 μM in 3 cm³), corresponding to an Hg²⁺ to N719 dye ratio of approximately 1 to 5. This observation suggests that the process responsible for the color change of the N719 dye involves a chemical transformation catalyzed by the Hg²⁺ ions rather than the formation of a 1:1 complex. The kinetic data shown in FIG. 2 are consistent with a catalytic mode of action, with the rate of color change increasing as the Hg²⁺ concentration is increased. However, the saturation in the color change observed for all Hg²⁺ concentrations at long times implies that the reaction is only partially catalytic, with the Hg²⁺ being rapidly consumed in the reaction.

We assign the hypsochromic shift of the N719 absorption band observed in the presence of Hg²⁺ ions to a transformation of the NCS ligands of this dye. Previous studies have reported a blue shift of the N719 absorption in the presence of chemical oxidants (such as H₂O₂) or after long period irradiation of the film; under these conditions this blue shift has been assigned to loss of sulfur from the NCS ligand leading to formation of coordinated cyanide. Our assignment of the hypsochromic shift observed here to transformation of the NCS ligands was further supported by FIR and Raman spectra, which both showed that immersion of the film in Hg²⁺ solutions resulted in a disappearance of the 2105 cm⁻¹ band assigned previously to the CN vibration of the NCS ligand.

### Example 5

### Use of TiO₂/N719 Films to Detect Other Metals

TiO₂/N719 films were used to detect other soft metals, i.e., Pt²⁺, Pd²⁺ and Ag⁺. In all cases, a hypsochromic shift of the TiO₂/N719 film absorption was observed, consistent with the proposed desulfurization of the N719 NCS ligands.

### Example 6

### Solution Based Mercury Detection

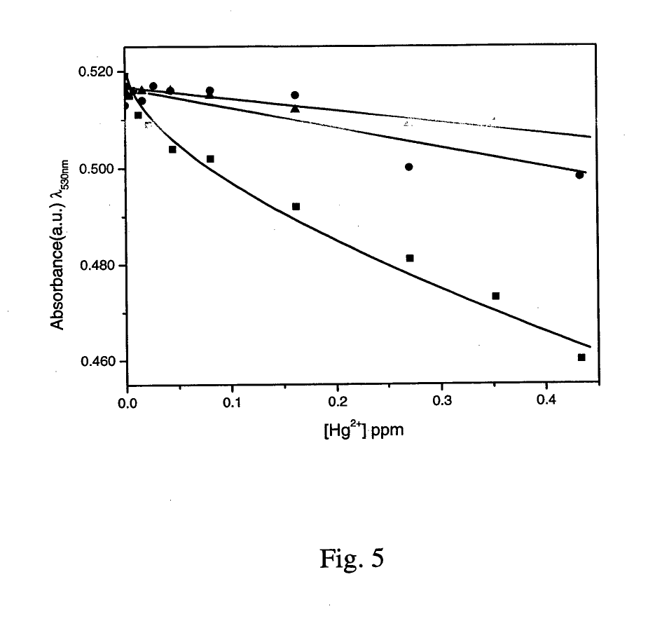

Mercury detecting experiments with N719 in ethanol solution were carried out with different metal ions being added from aqueous stock solutions. The solution based sensor allowed detection of mercury at levels of about 0.02-0.05 ppm as illustrated in FIG. 5.

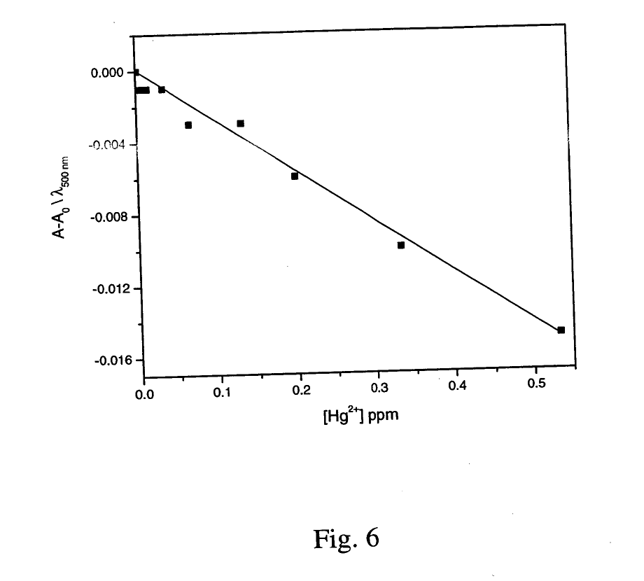

Mercury detecting experiments with N719 in water solution (KN719) using HEPES buffer (pH 7.0) were carried out with different metal ions being added from distilled water stock solutions. The solution based sensor allowed detection of mercury at levels of 0.1 ppm as illustrated in FIG. 6.

Various modifications of the invention, in addition to those described herein, will be apparent to one skilled in the art from the foregoing description. Such modifications are intended to fall within the scope of the appended claims.

What is claimed is:

1. A method for detecting one or more metals in an aqueous solution comprising contacting a metal organic dye with an aqueous solution comprising one or more metals or salts thereof selected from the group consisting of Pt²⁺ Pd²⁺, Ag⁺, Hg²⁺ and Au³⁺, wherein the presence of one or more of the metals is determined by a change in an optical and/or electrochemical property of the dye.

2. The method of claim 1, wherein the dye comprises a metal organic chromophore which comprises a ligand which is sensitive to the presence of one or more of the metals.

3. The method of claim 2, wherein the dye comprises a metal organic chromophore which comprises a sulfur containing ligand.

4. The method of claim 3, wherein the sulfur containing ligand is —N═C═S, —S—H or —NH—C(S)—NHR, wherein R is an alkyl group or an aryl group.

5. The method of claim 1, wherein the metal organic dye further comprises one or more solubilizing ligands.

6. The method of claim 5 wherein the one or more solubilizing ligands are a hydrophilic sugar, a protein, a polymer or a mixture of two or more thereof.

7. The method of claim 5, wherein the one or more solubilizing ligands is selected from the group consisting of albumin, dextran, sepharose, polyribose, polyxylose, polyvinyl alcohol, ethylene glycol, propylene glycol or a mixture of two or more thereof.

8. The method of claim 1, wherein the metal organic dye is a compound of Formula (II): 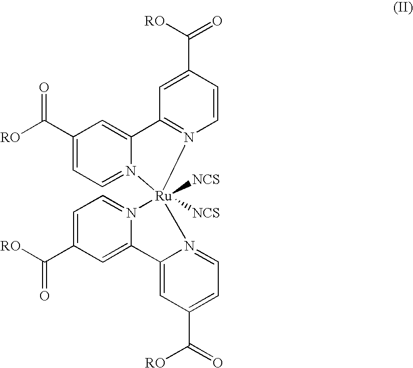
wherein each R is independently hydrogen or a solubilizing ligand selected from the group consisting of a hydrophilic sugar, a protein and a polymer.

9. The method of claim 1, wherein the metal organic dye is a compound of Formula (II): 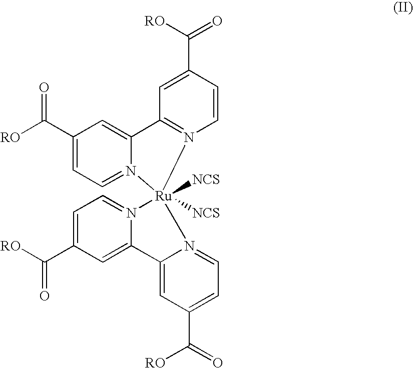
wherein each R is independently hydrogen or a solubilizing ligand selected from the group consisting of albumin, dextran, sepharose, polyribose, polyxylose, polyvinyl alcohol, ethylene glycol and propylene glycol.

10. The method of claim 1, wherein the metal organic dye is initially solubilized in a liquid phase.

11. The method of claim 10, wherein the liquid phase is aqueous.

12. The method of claim 10, wherein the liquid phase is a water-miscible organic solvent.

13. The method of claim 1, wherein the metal organic dye is supported on a substrate.

14. The method of claim 13, wherein the substrate is a metal oxide film.

15. The method of claim 14, wherein the metal oxide film comprises a mesoporous nanocrystalline metal oxide.

16. The method of claim 14, wherein the metal oxide is TiO₂, ZnO₂, ZrO₂, SiO₂, SnO₂, Nb₂O₅, WO₃, SiTiO₃ or a mixture of two or more thereof.

17. The method of claim 13, wherein the substrate is a polymer, an organic matrix, an inorganic matrix, an ordered aluminosilicate, an amorphous aluminosilicate or a mixture of two or more thereof.

18. The method of claim 13, wherein the metal organic dye-supporting substrate is TiO₂ bis(2,2′-bipyridyl-4,4′-dicarboxylato)ruthenium(II) bis-tetrabuytlammonium bis-thiocyanate.

19. The method of claim 13, wherein the presence of one or more of the metals is determined by a change in the color of the dye.

20. The method of claim 13, wherein the change in the optical property of the dye is determined by visual examination.

21. The method of claim 13, wherein the change in the optical property of the dye is measured by spectroscopy.

22. The method of claim 21, wherein the change in absorbance is measured by IR, UV-vis absorption, UV-vis emission, luminescence and/or Raman spectroscopy.

23. The method of claim 13, wherein the change in the electrochemical property of the dye is determined by electrochemical methods.

24. The method of claim 23, wherein the change in the electrochemical property of the dye is determined by cyclic voltammetry.

25. The method of claim 13, wherein the change in the optical and electrochemical property of the dye is determined by spectroelectrochemical methods.

26. The method of claim 1, wherein the one or more metals is mercury.

27. The method of claim 26, wherein the absorption of the dye changes from about 535 nm to about 481 nm when the metal organic dye is contacted with mercury.

28. The method of claim 1, wherein the aqueous solution is drinking water.

29. The method of claim 1, wherein the aqueous solution is a biological or medical fluid or tissue, or suspension thereof.

30. The method of claim 26, wherein the mercury is in the form of a metal organic complex.

31. A method for detecting one or more metals in an aqueous solution comprising contacting a metal organic dye with an aqueous solution comprising one or more metals or salts thereof selected from the group consisting of Pt²⁺ Pd²⁺, Ag⁺, Hg²⁺ and Au³⁺, wherein the presence of one or more of the metals is determined by measuring one or more optical and/or electrochemical properties of the dye.

32. A detector for detecting the presence of mercury or salts thereof in an aqueous solution comprising a metal organic dye.

33. The detector of claim 32, wherein the metal organic dye is supported on a substrate.

34. The detector of claim 33, wherein the substrate is a metal oxide film.

35. The detector of claim 33, wherein the metal organic dye-supporting substrate is supported on a support surface.

36. The detector of claim 35, wherein the support surface is a polymeric or silicate glass matrix.

37. The detector of claim 32, wherein the dye further comprises one or more ligating groups to attach the metal organic dye to the substrate.

38. The detector of claim 32, wherein the metal organic dye further comprises one or more solubilizing ligands.

39. The detector as claimed in claim 37 wherein the metal organic dye is a compound of formula (II): 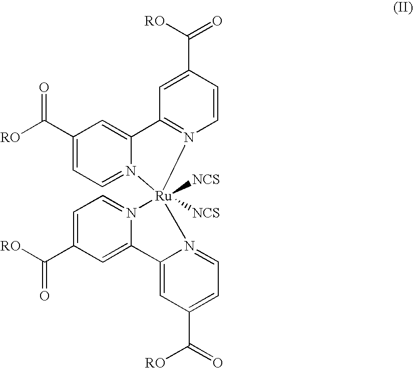
wherein each R is independently hydrogen or a solubilizing ligand selected from the group consisting of a hydrophilic sugar, a protein and a polymer.

40. The detector of claim 32, further comprising an optical sensor and/or an electrochemical sensor to detect the presence of the one or more metals by determining the change in one or more optical and/or electrochemical properties of the dye.

41. The detector of claim 32, wherein the detector is in the form of a device, a kit or a device and a kit.

42. A process for producing a metal organic dye-supporting substrate comprising contacting a substrate with a metal organic dye.

43. The process of claim 42, comprising applying the metal organic dye-supporting substrate to a support surface with heat and/or pressure.

44. The process of claim 42, further comprising applying the substrate to a support surface followed by the addition of the metal organic dye.

45. The process of claim 42, wherein the substrate and/or the metal organic dye is applied by screen printing.
